(19) United States
(12) Patent Application Publication
(10) Pub. No.: US 2026/0236114 A1
(43) Pub. Date: Aug. 13, 2026

(54) REMOTE ASSISTANCE FOR AGRICULTURAL DISPLAY METHODS AND RELATED DEVICES AND SYSTEMS

(71) Applicant: Ag Leader Technology, Ames, IA (US)

(72) Inventors: Mike Fulker, Nevada, IA (US); Mitchell Geistkemper, Slater, IA (US); Qian Zhang, Ames, IA (US)

(21) Appl. No.: 19/534,324

(22) Filed: Feb. 9, 2026

Related U.S. Application Data
(60) Provisional application No. 63/755,675, filed on Feb. 7, 2025.

(51) Int. Cl. G06F 3/038; G06F 3/0481; G06F 3/04883

(52) U.S. Cl. CPC G06F 3/038; G06F 3/0481; G06F 3/04883

(57) ABSTRACT

A safety-constrained remote interaction with an agricultural display that controls or monitors vehicle and implement operations. A bidirectional session between a remote terminal and the in-cab display renders a view of the display user interface and receives remote inputs that are translated to display-space coordinates. The display identifies a target user interface element using a hierarchical representation and applies remote-interaction safety rules before fabricating and delivering a simulated input event. Safety rules prohibit remotely initiating mechanical operations and block activation when a mechanism is in a mid-maintenance state, including via ancestor-level policies set by remote-click-prohibited flags and statically defined prohibited object names. When an action is denied, the system suppresses the event; when allowed, it may render a transient confirmation cue. The system selectively disables high-risk functions during remote sessions to improve operator and machine safety while enabling prompt, guided assistance for configuration and related tasks.

### CROSS-REFERENCE TO RELATED APPLICATION(S)

This application claims the benefit under 35 U.S.C. § 119(e) to U.S. Provisional Application 63/755,675, filed Feb. 7, 2025, and entitled Remote Assistance for Agricultural Display Methods and Related Devices and Systems, which is hereby incorporated herein by reference in its entirety for all purposes.

### TECHNICAL FIELD

The disclosure relates to agricultural displays, operation, and remote control.

### BACKGROUND

Most approaches to a remote screen viewing solution with an included remote-control feature use a simulated mouse to propagate inputs to the target device.

### BRIEF SUMMARY

In Example 1, a system for remote interaction with an agricultural display, the system comprising a remote terminal configured to render, in real time, a visual representation of a user interface of the agricultural display and to receive user input at coordinates corresponding to locations within the visual representation, a communications interface configured to establish a bidirectional remote session between the remote terminal and the agricultural display, and one or more processors and memory storing instructions executable to: translate the coordinates of the user input from the remote terminal to display-space coordinates of the agricultural display; identify, based on the display-space coordinates and a hierarchical representation of user interface elements of the agricultural display, a target user interface element; apply one or more remote-interaction safety rules; and when the one or more remote-interaction safety rules permit interaction, generate a simulated input event delivered directly to the target user interface element, and when the one or more remote-interaction safety rules prohibit interaction, suppress the simulated input event.

Example 2 relates to the system of any of claims 1 and 3-9, wherein the one or more processors are further configured to determine, for the remote session, that in-cab consent has been granted for remote control of the user interface, and maintain a control-consented state during a control interval.

Example 3 relates to the system of any of claims 1-2 and 4-9, wherein the remote-interaction safety rules include one or more of a prohibition against remotely triggering mechanical operations and a prohibition against remote activation while an associated mechanism is in a mid-maintenance state.

Example 4 relates to the system of any of claims 1-3 and 5-9, wherein when the one or more remote-interaction safety rules prohibit interaction a denial indicator is presented on at least one of the agricultural display and the remote terminal.

Example 5 relates to the system of any of claims 1-4 and 6-9, wherein the hierarchical representation comprises a tree of user interface elements and the identifying of the target user interface element includes determining a frontmost or lowest-in-hierarchy element intersecting the display-space coordinates.

Example 6 relates to the system of any of claims 1-5 and 7-9, wherein the one or more remote-interaction safety rules include detecting, by traversing ancestors of the target user interface element in the hierarchical representation, whether any ancestor element is marked with a remote-click-prohibited flag or has an object name matching a statically defined prohibited list, and aborting the simulated input event upon such detection.

Example 7 relates to the system of any of claims 1-6 and 8-9, wherein the instructions are further executable to prohibit remote interaction with an entire region of the user interface by marking an ancestor element corresponding to the region with a remote-click-prohibited flag.

Example 8 relates to the system of any of claims 1-7 and 9, further comprising a session-timer manager configured to enforce a maximum control interval for the control-consented state, terminate the control-consented state upon expiration of the maximum control interval, and require re-confirmation of in-cab consent to resume remote control.

Example 9 relates to the system of any of claims 1-8, wherein the simulated input event comprises at least one of: a mouse-button press, a mouse-button release, a mouse-drag, a touch-down, a touch-move, and a touch-up.

In Example 10, a method for safety-constrained remote interaction with an agricultural display, the method comprising: establishing a bidirectional remote session between a remote terminal and the agricultural display; obtaining in-cab consent to enable a control-consented state for a time-bounded control interval; receiving, from the remote terminal, coordinates of a user input corresponding to a rendered view of the agricultural display; translating the coordinates to display-space coordinates of the agricultural display; identifying, using a hierarchical representation of user interface elements, a target user interface element intersecting the display-space coordinates; evaluating one or more remote-interaction safety rules; and when permitted under the one or more remote-interaction safety rules, generating a simulated input event delivered to the target user interface element, and when not permitted, suppressing the simulated input event and presenting a denial indicator on at least one of the agricultural display and the remote terminal.

Example 11 relates to the method of any of claims 10 and 12-15, wherein the one or more remote-interaction safety rules include one or more of a prohibition against remotely triggering mechanical operations and a prohibition against remote activation while an associated mechanism is in a mid-maintenance state.

Example 12 relates to the method of any of claims 10-11 and 13-15, further comprising traversing ancestors of the target user interface element to detect at least one of a remote-click-prohibited flag or a prohibited object name, and, upon detection, suppressing the simulated input event.

Example 13 relates to the method of any of claims 10-12 and 14-15, further comprising prohibiting remote interaction with all user interface elements that are descendants of an ancestor element designated as remote-click-prohibited.

Example 14 relates to the method of any of claims 10-13 and 15, wherein identifying the target user interface element comprises selecting a frontmost or lowest-in-hierarchy element among a plurality of elements that overlap the display-space coordinates.

Example 15 relates to the method of any of claims 10-14, further comprising enforcing expiration of the control-consented state upon lapse of the time-bounded control interval and requiring renewed in-cab consent to resume remote control.

In Example 16, a non-transitory computer-readable medium storing instructions that, when executed by one or more processors of an agricultural display, cause the processors to perform operations comprising: coordinating a bidirectional remote session with a remote terminal; establishing, upon in-cab confirmation, a control-consented state for a remote control interval; receiving remote user input comprising coordinates mapped to display-space coordinates of a user interface of the agricultural display; identifying a target user interface element based on the display-space coordinates and a hierarchical representation of the user interface; and applying one or more remote-interaction safety rules, wherein when permitted under the one or more remote-interaction safety rules, a simulated input event is delivered to the target user interface element, and when not permitted, the simulated input event is suppressed and a denial indicator is rendered on at least one of the agricultural display and the remote terminal.

Example 17 relates to the non-transitory computer-readable medium of any of claims 16 and 18-20, wherein the one or more remote-interaction safety rules include one or more of a prohibition against remotely triggering mechanical operations and a prohibition against remote activation while an associated mechanism is in a mid-maintenance state.

Example 18 relates to the non-transitory computer-readable medium of any of claims 16-17 and 19-20, wherein the operations further comprise traversing ancestor elements in the hierarchical representation to detect a remote-click-prohibited flag or an object name in a prohibited list, and suppressing the simulated input event upon such detection.

Example 19 relates to the non-transitory computer-readable medium of any of claims 16-18 and 20, wherein the operations further comprise selecting a frontmost or lowest-in-hierarchy element intersecting the display-space coordinates when multiple user interface elements overlap the display-space coordinates.

Example 20 relates to the non-transitory computer-readable medium of any of claims 16-19, wherein the operations further comprise enforcing a session timer that terminates the control-consented state upon expiration, and requiring renewed in-cab consent to continue remote control.

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic representation of a remote user interface according to one implementation.

FIG. 2 is a hierarchical representation of user interface elements, according to one implementation.

FIG. 3 is a schematic representation of a remote user interface with a click, according to one implementation.

FIG. 4 is a hierarchical representation of user interface elements processing the click of FIG. 3, according to one implementation.

FIG. 5 is a schematic representation of a remote user interface with the disallowed click of FIGS. 3 and 4, according to one implementation.

FIG. 6 is a schematic representation of a remote user interface with a click, according to one implementation.

FIG. 7 is a hierarchical representation of user interface elements processing the click of FIG. 6, according to one implementation.

FIG. 8 is a flow diagram of various steps of the system, according to one implementation.

### DETAILED DESCRIPTION

The herein disclosed system, methods, and devices bring remote control of an agricultural display to users to help users receive remote assistance with issues, such as configuration, more promptly than verbal instruction affords. The described systems, methods, and devices do not allow for the remote user to click on a button/field and activate mechanical operations. Additionally, the systems, methods, and devices do not allow for a remote user to activate a mechanism when that mechanism is in a mid-maintenance state.

RealVNC is a well known and widely used remote access software. Their approach to remote control and similar other off-the-shelf known solutions are generic products that are not customized to the UI or application they are sending inputs to. That is, these prior kwon remote access solution allow for clicks/activation of any item at any time. This type of permissive control creates real safety concerns and mechanical risks when implemented on an agricultural display. An agricultural display being a display that is used to control a tractor, an implement, or other agricultural process and provide feedback to an operators, such as InCommand® from Ag Leader®.

The herein disclosed solution builds on SignalR-based viewing sessions (described below), and also builds on the mechanism that both users agree to a warning/consent prompt before remote control can start.

In various implementations, the system and methods are configured to execute various steps on one or more processors. Various additional hardware, software, and firmware components may be necessary to execute the various steps of the system and method as would be understood. As will also be understood, the various of the step are optional and may be preformed in any order or not at all. Some steps may be performed more than one. Additionally, a step or steps may be preformed sequentially, iteratively, and/or simultaneously.

Various steps of the solution are outlined here. It would be understood the each of these steps is optional and the various steps may be performed in any order or not at all. Certain steps may be repeated or performed sequentially or iteratively.

In a first step a remote connection is established between a remote user and a display. In many implementation, the remote user and the display are in separate geographic locations, for example the display may be in user on an agricultural vehicle in a field, while the remote user and their terminal may be located in a data or support center in a different city, town, state, or even country. The remote connection described herein will be a SignalR connection, but it would be understood by those of skill in the art that alternative technologies for remote connection may be used without deviating from the teaching of this disclosure.

Additionally, the system is described below in reference to a Qt UI framework, but the same principles can apply to a myriad of UI frameworks. Including those frameworks that include hierarchical graphical objects and the ability to assign invisible names/flag-values to the elements/objects.

In an optional step, a remote user clicks the remotely viewed display, selecting that display or portion thereof.

In another optional step, browser-side code captures the click on an HTML5 canvas, or other coordinate system, and translates the coordinates to be relativized to the display's screen resolution. That is, code on the side of the remote user translates the location of the click from the remote user's terminal to a corresponding location on the display.

In a further optional step, a message representing the click action, including the click coordinates, is sent over the remote connection, such as a SingalR connection, already established for the remote session.

In another step, the remote connection server, optionally a Signal R server, propagates the message to the display. The message may be sent by any wireless technology, such as WiFi, Bluetooth, radio, etc. as would be appreciated.

In a further optional step, the display receives the message with the click coordinates.

The display code, another optional step, checks that the remote session is currently in a control-consented state (i.e. the browser/remote user initiated control and the in-cab, display, user agreed to the remote session). In some implementations, the remote session may include a max duration for the control interval, such that after the max duration has elapsed the control permissions are terminated and may need to be reinitiated or reaffirmed.

In another optional step, the display code determines the element, optionally a Qt UI widget, at the point on display screen that matches the coordinates sent in the message. In one implementation, if multiple elements overlap at the coordinates, the system is configured to choose the element in front. In the Qt framework, the elements are hierarchical, and the system is configured to choose the element that is “lowest”/closest-to-leaf in the hierarchy that still intersects the coordinate

In a further optional step, the display code traverses the UI hierarchy upward, checking if the element is marked with a special object flag value meaning “no remote clicks allowed” and if the element's object name is in a statically-defined list of prohibited names for disallowing remote clicks. If either is true, the system of configured to abort the click. That is, not allow the click to execute on the display. Optionally the system may show a “not allowed” icon at that coordinate on screen, visible to either or both of the in-cab and remote users.

If no ancestor elements in the hierarchy are remote-click-prohibited, then the system is configured use Qt's mechanism to fabricate a simulated mouse event and send it directly to the UI element found at the coordinates.

In some implementations, ss an additional informational benefit to the in-cab user, the system may also temporarily show a special cursor icon at that coordinate to indicate that a successful click occurred.

The system allows for the prohibition of remote clicks from entire sections of the UI at once by marking the appropriate ancestor element. For example, the system may block an entire dialog window and all its buttons from being remotely clicked, rather than change each button in the code.

Various agricultural displays include a mix of both Qt Widget and Qt QML frameworks, while other hierarchical graphical frameworks are also possible. Various additional code for UI element acquisition+UI element traversal, may be required for such certain displays, but the same general approach as discussed above is followed.

The steps described above are specific to mouse button presses, but the same steps may be used for mouse button releases and mouse “drag” movements, and other input events as would be understood. In various implementations, the browser/remote terminal may include an “input event type” with the message when sending the coordinates and other data to the display. The display will continue to execute the allowance checks as appropriate, and (if allowed) fabricate the simulated input event with the corresponding type.

Similar principles can apply for remote touch inputs from touchscreen devices. In fact, touch-screen browsers may be operated by converting touch inputs into mouse-like event types.

This solution improves safety for allowing remote control of an agricultural display, while prohibiting a remote user to initiating actions controlled by the display that may put an operator, use, or machinery at risk.

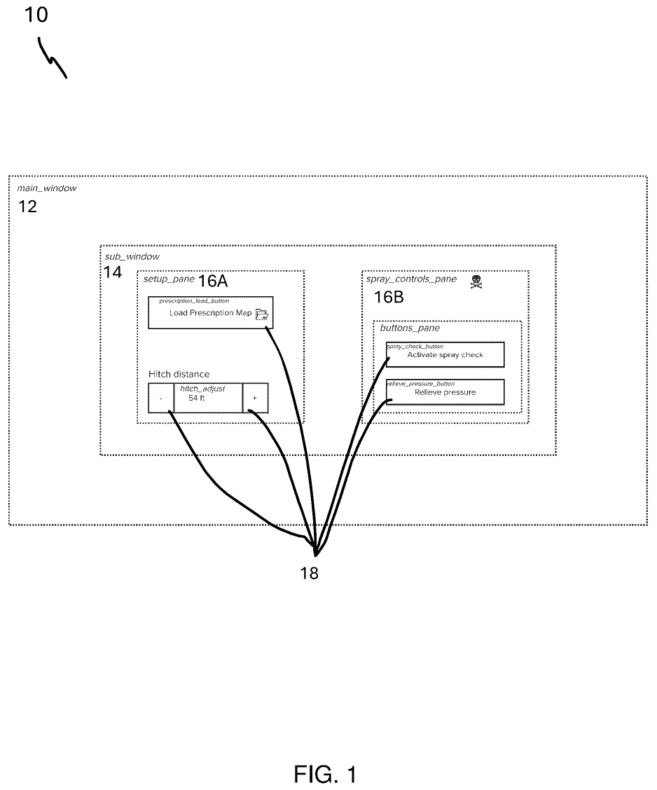

Turning now to the figures in more detail. FIG. 1 shows an exemplary remote user terminal having a main window 12 and a sub-window 14 representing the agricultural display. As would be understood the agricultural display 14 may include one or more panes 16, such as a set up pane 16A and a spray control pane 16B, other panes 16 would be recognized by those of skill in the art. The display 14 and panes 16 may also include one or more clickable/selectable buttons 18 or other interactive elements 18, as would be appreciated.

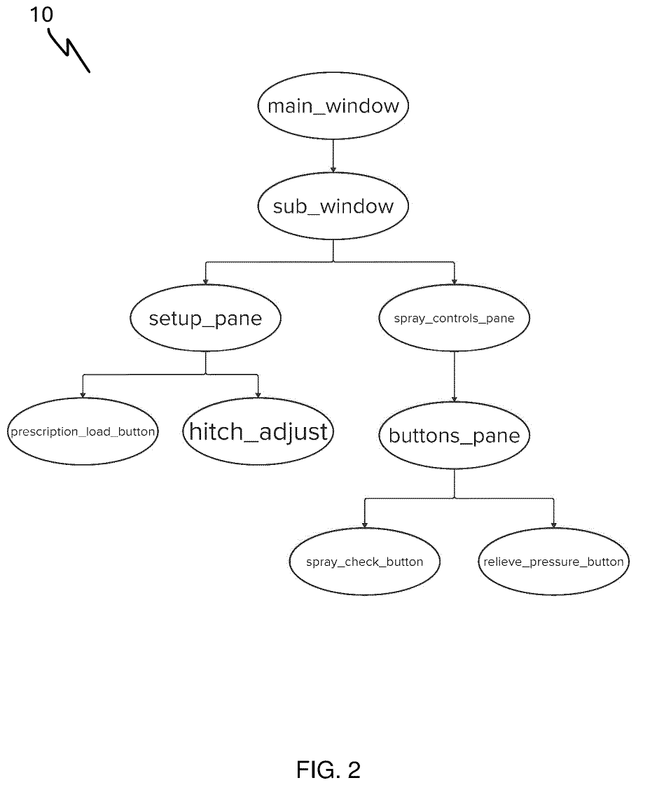

Shown in the FIG. 2 the various elements 12, 14, 16, 18 of the remote user terminal and display are in a hierarchical order. In this example, the sub-window or display 14 being below the main window 12 of the remote user terminal. The setup pane 16A or the spray controls pane 16B being below the display window 14. The various buttons 18 being below the panes 16.

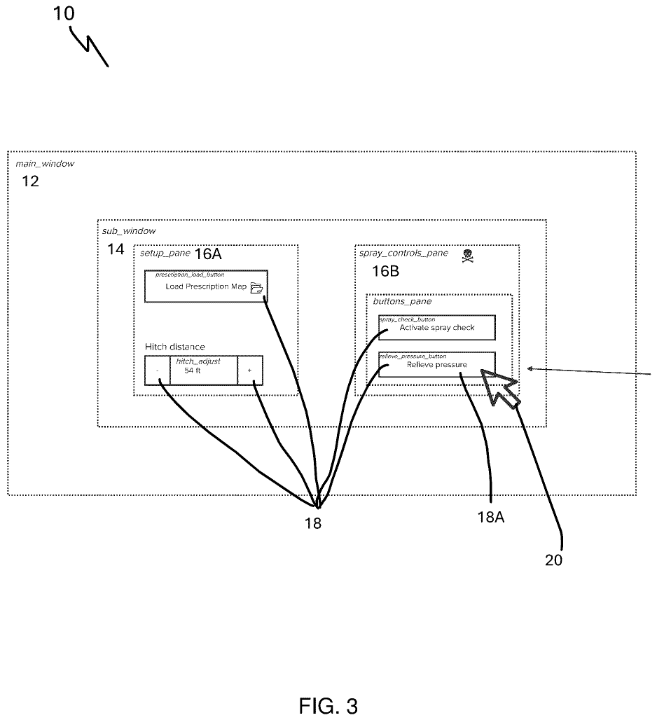

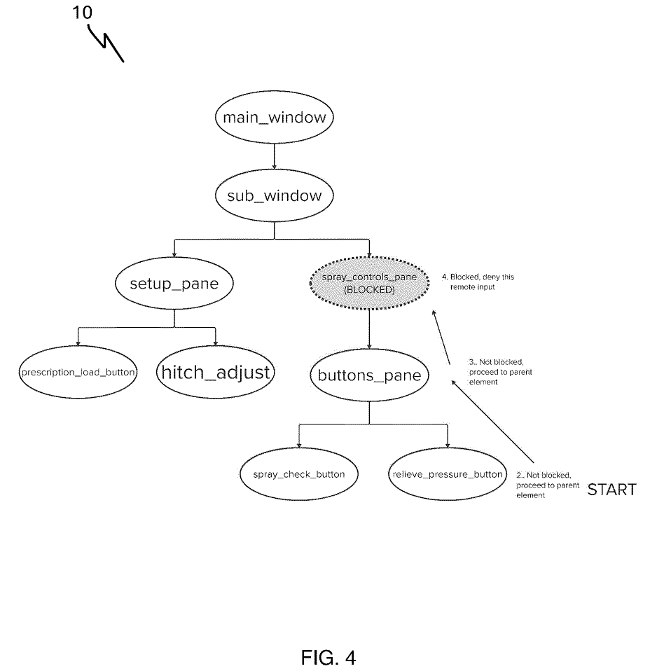

FIG. 3 shows the system 10 in use, where a remote user, initiates a click on the relieve pressure button 18A with a cursor 20, mouse click or other selection function as would be understood, such as use of a touch screen. FIG. 4 shows the hierarchical functioning and logical control for the exemplary click of FIG. 3. Herein, the system 10 is configured to allow selection of the relieve pressure button 18A, because this is allowed the system 10 then goes to the next hierarchical level to determine if the click is allowed. Here, the buttons pane 16C is allowed to be selected. In the next check on the hierarchical levels, the spray controls pane 16B, is not allowed to be accessed and as such the remote click/selection of the relieve pressure button 18A is not allowed and is instead denied.

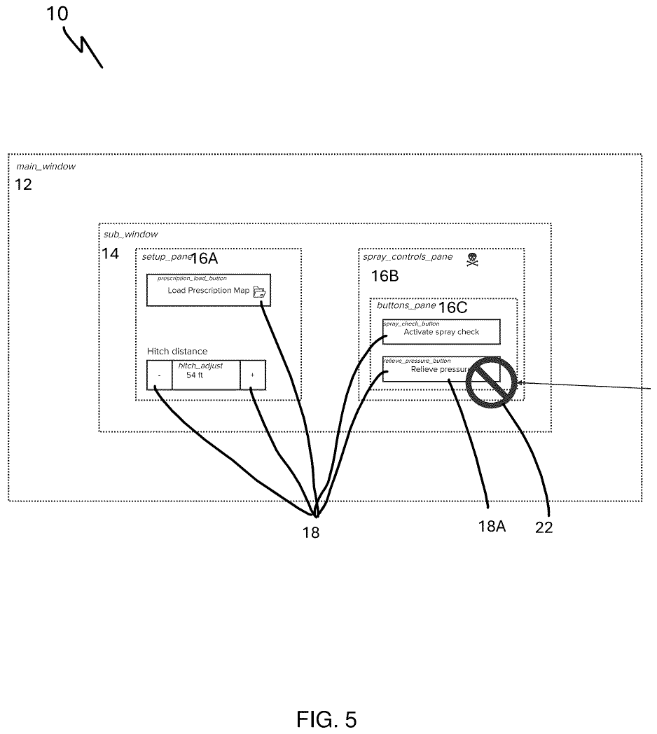

FIG. 5 shows an exemplary implementation where upon denial of a click/selection the system 10 displays an icon 22 optionally on the remote user interface 12 and/or the display 14 indicating that the input was denied. Here the icon 22 is an prohibited symbol, but may be any selected icon or symbol.

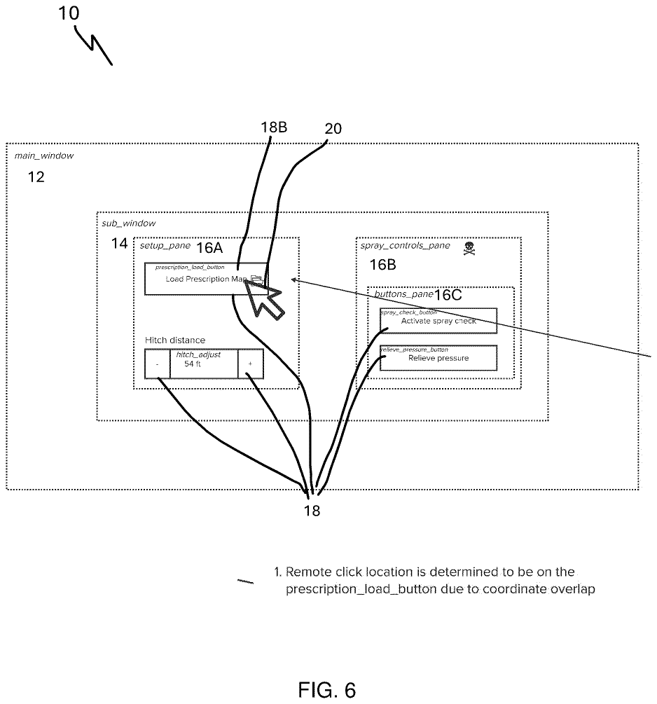

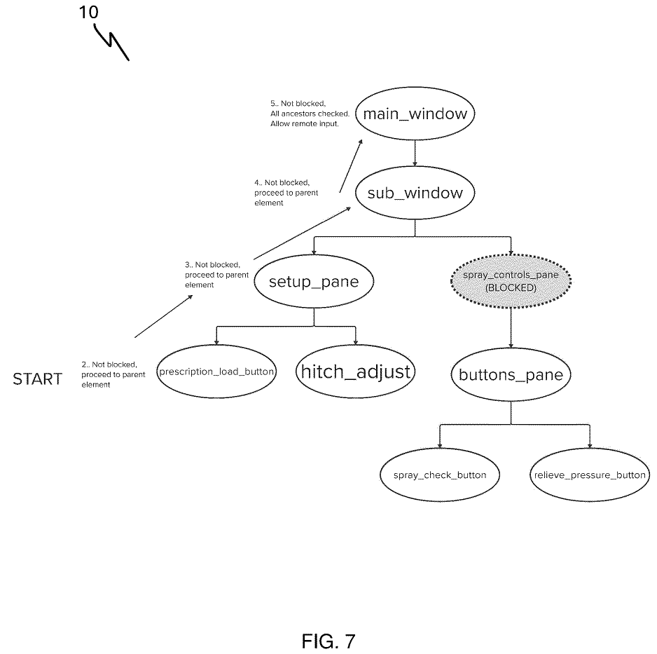

FIGS. 6 and 7 show a further example. In this example a remote click is determined to be on the prescription load button 18B via the cursor 20 mouse click and coordinate overlap. Here the system 10 then check each of the hierarchical levels to determine if the click/selection is allowed. Here at no level is the click/selection blocked, shown in FIG. 7, so the click is allowed and the remote user may proceed with further steps.

In various implementations, the remote user interface may be implemented on a cloud platform, such as AgFiniti® from Ag Leader®.

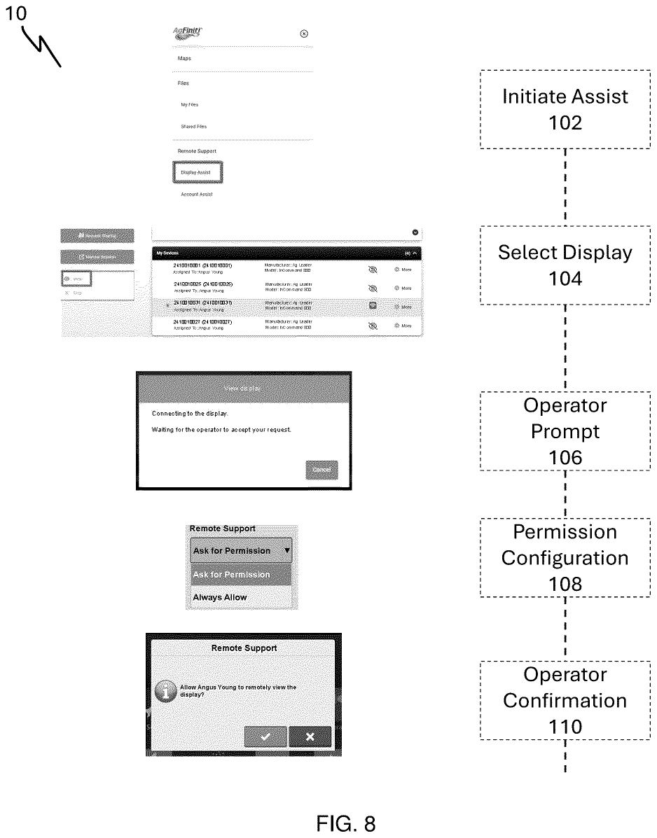

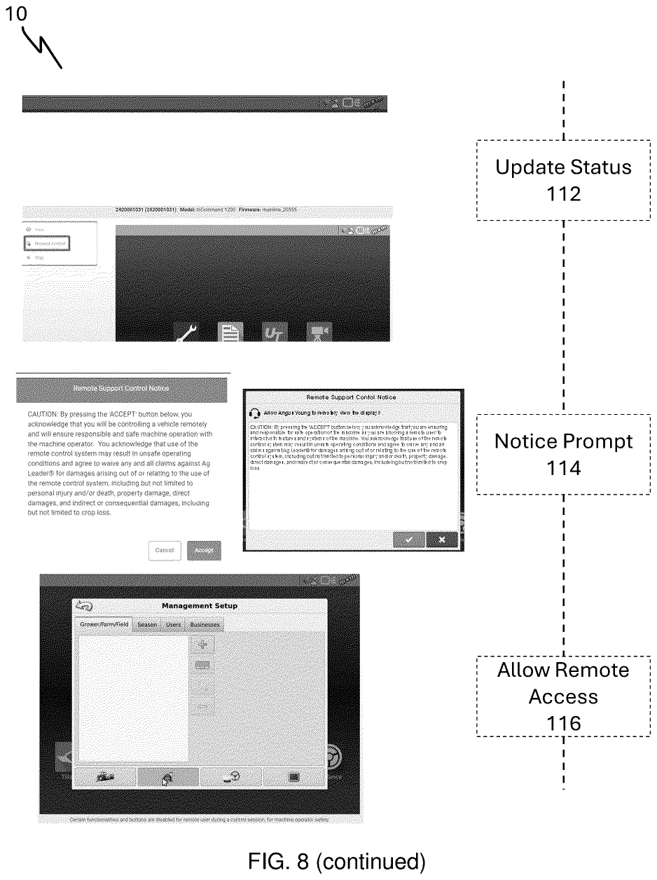

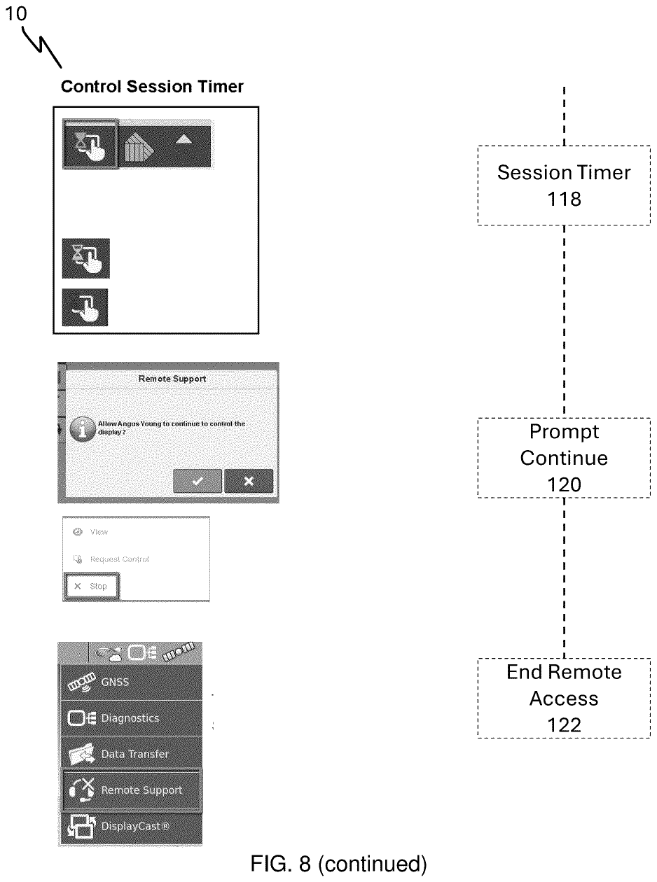

FIG. 8 shows an exemplary implementation of the system with exemplary User Interface screens. In various implementations, the system 10 may be initiated by a remote user selection to initiate remote assistance (box 102). The remote user may also select the particularly agricultural display they wish to view and/or interact with (box 104). In certain implementations the system 10 will then prompt a user of the display to accept the request for remote access/assistance (box 106).

In certain implementations, the display may be configured to always allow remote access, always ask for permission for remote access, allow remote access for a specified time period, or other configuration as would be understood. In these and other implementations, the system 10 may check the permission configuration (box 108) of the display requested to be accessed and either allow, disallow, or prompt access. In some implementation the display user is prompted to allow access (box 110) and may allow or deny access.

If and when a remote session is initiated a statue bar or other indicator of such initiation may be updated, for example by changing color (box 112).

In some implementations, upon or prior to initiation of the remote session one or both of the remote user and the display user may be prompted to read and acknowledge a remote support notice or other disclaimer regarding the session (box 114).

In a further step, the system 10 allows remote access to the display for the remote user (box 116). In various implementations, the system 10 is configured for certain functions/buttons to be disable during a remote control session, such as for machine and/or operator safety. In various implementations, if a button that is disabled is selected the cursor 20 icon 22 may change to indicated that the selection is disabled (see FIGS. 3 and 5 where the cursor changes from an arrow to a prohibited icon upon selected a disallowed button). For functions that may be disable for a remote user during a remote session may include liability notices, reset timer for control, operator presence, engaging steering, steering menus, manual steering commands, universal terminal screens, spinner spreader engage, NH₃ tube check, NORAC engage, plow controls, boom pressure relief, and other functions as would be understood and configured by an individual system 10.

In some implementations, the system 10 may include a control session timer (box 118). The control session timer may have a visual indicator on a screen of the display and/or remote terminal to show the operators how much time is remaining in the session before the session will end or may need to be reset. In various implementation, a color or other indicator may be included to show the operators how much time is left in the sessions. For example, a yellow icon when 1 minutes is remaining and a red icon with 30 second remain.

In certain implementations, when the time for the remote session has elapsed the system 10 may prompt the users to either continue to allow control (box 120) or end the session (box 122). In various implementations, either party may end the remote control session at any time (box 122).

The techniques, processes, and steps described herein may be implemented, in whole or in part, as computer-implemented processes executed by one or more computing systems. In certain implementations, the disclosed methods are carried out by program code stored on a non-transitory computer-readable medium and executed by one or more processors. In other implementations, dedicated hardware such as application-specific integrated circuits (ASICs), field-programmable gate arrays (FPGAs), digital signal processors (DSPs), or system-on-chip (SoC) devices may implement all or portions of the functionality described herein. Hybrid implementations combining software and hardware are also contemplated.

In various implementations, a computing system includes one or more processors coupled to memory, persistent storage, and input/output (I/O) interfaces over one or more buses. The processors may include central processing units (CPUs), graphics processing units (GPUs), tensor processing units (TPUs), neural processing units (NPUs), or other general-or special-purpose processing devices. The memory may include volatile memory (e.g., RAM) and non-volatile memory (e.g., flash, ROM). The storage may include magnetic, optical, or solid-state devices. The I/O interfaces may include network interfaces, display controllers, keyboard and pointing device controllers, touchscreen interfaces, cameras, microphones, sensors, and other peripherals. A network interface may provide connectivity over wired or wireless links, including Ethernet, Wi-Fi, Bluetooth, cellular (e.g., 4G/5G), satellite, or other protocols.

In some implementations, the computing system operates in a client-server or multi-tier architecture. For example, a client device (e.g., a smartphone, tablet, laptop, desktop computer, or embedded system) executes a client application that communicates with one or more servers over a network. The servers may include application servers, database servers, or microservices deployed in an on-premises environment, a private cloud, a public cloud, or a hybrid cloud. Load balancers, API gateways, message queues, and container orchestration platforms (e.g., Kubernetes) may support scalability and resilience. Data may be stored in relational databases, NoSQL stores, object stores, in-memory caches, or distributed file systems, with appropriate indexing, partitioning, replication, and consistency controls.

The functionality described herein may be organized into modules, components, services, or engines implemented in software, firmware, hardware, or combinations thereof. A “module” or “component” refers to executable instructions, logic, circuitry, or combinations thereof that perform the described operations. Modules may run on a single device or be distributed across multiple devices or services. Inter-module communication may be implemented via function calls, remote procedure calls (RPCs), message queues, publish/subscribe mechanisms, RESTful or gRPC interfaces, or other suitable techniques.

Any process, workflow, or algorithm described herein may be implemented as computer-executable instructions that, when executed by one or more processors, cause the processors to perform the steps of the process. Unless expressly stated otherwise, the order of steps is not limiting, and steps may be performed in parallel, omitted, repeated, combined, subdivided, or reordered to achieve substantively equivalent results. Loops, branches, and conditional operations may be implemented using control flow constructs. Data transformations may be expressed as functional pipelines, directed acyclic graphs (DAGs), or state machines.

By way of non-limiting example, in a representative implementation, the processor(s) execute instructions to: (1) receive or acquire input data from one or more sources via the I/O interfaces or network interface; (2) pre-process the input data (e.g., validation, normalization, filtering, parsing, tokenization, encoding, compression, or encryption/decryption as applicable); (3) process the data according to the techniques described herein, which may include one or more of: rule-based evaluation, statistical analysis, optimization, simulation, search, inference, pattern recognition, or machine learning-based operations; (4) generate output data, results, or control signals; and (5) store the results to memory or storage and/or transmit the results to another device or service through the network interface, and optionally display or render the results via a user interface.

In certain embodiments, the subject matter is implemented as program code stored on one or more non-transitory computer-readable media. Suitable media include, without limitation, magnetic disks, optical disks, solid-state drives, flash memory devices, ROM, RAM, and other tangible storage media. The program code may be written in any suitable programming language, including low-level languages (e.g., C/C++), high-level languages (e.g., Java, C#, Go, Rust, Python, JavaScript/TypeScript), hardware description languages for hardware embodiments (e.g., Verilog, VHDL), or combinations thereof. The program code may be interpreted, compiled, or just-in-time compiled, and may run in virtual machines, containers, sandboxes, trusted execution environments, or bare-metal environments.

The disclosed techniques may be deployed in centralized, distributed, and/or edge computing environments. In distributed embodiments, computational tasks may be partitioned across nodes and coordinated using consensus protocols, distributed scheduling, or orchestration frameworks. Data consistency may employ eventual or strong consistency models as appropriate to the use case. Edge devices may pre-process data to reduce latency or bandwidth usage and may operate intermittently with synchronization occurring when connectivity is available. The system may employ caching layers, content delivery networks (CDNs), or peer-to-peer mechanisms to enhance performance and reliability.

Implementations may incorporate security features such as authentication, authorization, access control, encryption at rest and in transit, secure key management, secure boot, code signing, attestation, intrusion detection, anomaly detection, rate limiting, and audit logging. Data handling may comply with applicable legal or regulatory frameworks and industry standards. Privacy-preserving techniques (e.g., data minimization, anonymization/pseudonymization, differential privacy, secure multi-party computation, homomorphic encryption) may be employed where appropriate. Logging and telemetry may be configurable to capture operational metrics, performance data, and errors while adhering to privacy and security requirements.

Where applicable, implementations may include graphical user interfaces (GUIs), command-line interfaces (CLIs), web interfaces, mobile applications, application programming interfaces (APIs), or combinations thereof. GUIs may be implemented with standard UI frameworks and may present forms, dashboards, visualizations, notifications, and controls enabling users to invoke or configure the methods described herein. Accessibility considerations (e.g., screen reader compatibility, keyboard navigation, color contrast) may be incorporated.

The system may operate on data represented as structured records, relational tables, graphs, trees, key-value maps, JSON/XML/YAML documents, binary blobs, images, audio, video, or domain-specific formats. Serialization may use JSON, Protocol Buffers, Avro, Thrift, MessagePack, or other formats. Where appropriate, schemas may be versioned and validated to maintain backward and forward compatibility.

An example computing environment includes a user device comprising: at least one processor; memory storing instructions; a display; one or more input devices; and a network interface. The instructions, when executed by the processor, cause the device to perform any of the methods disclosed herein. In a networked implementation, the user device communicatively couples to an application server via a network. The application server comprises at least one processor, memory, persistent storage, and a network interface, and executes service logic implementing operations as described. A database server coupled to the application server stores data structures used and/or generated by the operations, and may support transactions, indexing, query processing, and backup/restore. The components may be geographically co-located or distributed.

Although the disclosure has been described with references to various embodiments, persons skilled in the art will recognize that changes may be made in form and detail without departing from the spirit and scope of this disclosure.

What is claimed is:

1. A system for remote interaction with an agricultural display, the system comprising:
(a) a remote terminal configured to render, in real time, a visual representation of a user interface of the agricultural display and to receive user input at coordinates corresponding to locations within the visual representation;
(b) a communications interface configured to establish a bidirectional remote session between the remote terminal and the agricultural display; and
(c) one or more processors and memory storing instructions executable to:
(i) translate the coordinates of the user input from the remote terminal to display-space coordinates of the agricultural display;
(ii) identify, based on the display-space coordinates and a hierarchical representation of user interface elements of the agricultural display, a target user interface element;
(iii) apply one or more remote-interaction safety rules; and
(v) when the one or more remote-interaction safety rules permit interaction, generate a simulated input event delivered directly to the target user interface element, and when the one or more remote-interaction safety rules prohibit interaction, suppress the simulated input event.

2. The system of claim 1, wherein the one or more processors are further configured to determine, for the remote session, that in-cab consent has been granted for remote control of the user interface, and maintain a control-consented state during a control interval.

3. The system of claim 1, wherein the remote-interaction safety rules include one or more of a prohibition against remotely triggering mechanical operations and a prohibition against remote activation while an associated mechanism is in a mid-maintenance state.

4. The system of claim 1, wherein when the one or more remote-interaction safety rules prohibit interaction a denial indicator is presented on at least one of the agricultural display and the remote terminal.

5. The system of claim 1, wherein the hierarchical representation comprises a tree of user interface elements and the identifying of the target user interface element includes determining a frontmost or lowest-in-hierarchy element intersecting the display-space coordinates.

6. The system of claim 1, wherein the one or more remote-interaction safety rules include detecting, by traversing ancestors of the target user interface element in the hierarchical representation, whether any ancestor element is marked with a remote-click-prohibited flag or has an object name matching a statically defined prohibited list, and aborting the simulated input event upon such detection.

7. The system of claim 1, wherein the instructions are further executable to prohibit remote interaction with an entire region of the user interface by marking an ancestor element corresponding to the region with a remote-click-prohibited flag.

8. The system of claim 1, further comprising a session-timer manager configured to enforce a maximum control interval for the control-consented state, terminate the control-consented state upon expiration of the maximum control interval, and require re-confirmation of in-cab consent to resume remote control.

9. The system of claim 1, wherein the simulated input event comprises at least one of: a mouse-button press, a mouse-button release, a mouse-drag, a touch-down, a touch-move, and a touch-up.

10. A method for safety-constrained remote interaction with an agricultural display, the method comprising:
establishing a bidirectional remote session between a remote terminal and the agricultural display;
obtaining in-cab consent to enable a control-consented state for a time-bounded control interval;
receiving, from the remote terminal, coordinates of a user input corresponding to a rendered view of the agricultural display;
translating the coordinates to display-space coordinates of the agricultural display;
identifying, using a hierarchical representation of user interface elements, a target user interface element intersecting the display-space coordinates;
evaluating one or more remote-interaction safety rules; and
when permitted under the one or more remote-interaction safety rules, generating a simulated input event delivered to the target user interface element, and when not permitted, suppressing the simulated input event and presenting a denial indicator on at least one of the agricultural display and the remote terminal.

11. The method of claim 10, wherein the one or more remote-interaction safety rules include one or more of a prohibition against remotely triggering mechanical operations and a prohibition against remote activation while an associated mechanism is in a mid-maintenance state.

12. The method of claim 16, further comprising traversing ancestors of the target user interface element to detect at least one of a remote-click-prohibited flag or a prohibited object name, and, upon detection, suppressing the simulated input event.

13. The method of claim 16, further comprising prohibiting remote interaction with all user interface elements that are descendants of an ancestor element designated as remote-click-prohibited.

14. The method of claim 16, wherein identifying the target user interface element comprises selecting a frontmost or lowest-in-hierarchy element among a plurality of elements that overlap the display-space coordinates.

15. The method of claim 16, further comprising enforcing expiration of the control-consented state upon lapse of the time-bounded control interval and requiring renewed in-cab consent to resume remote control.

16. A non-transitory computer-readable medium storing instructions that, when executed by one or more processors of an agricultural display, cause the processors to perform operations comprising:
coordinating a bidirectional remote session with a remote terminal;
establishing, upon in-cab confirmation, a control-consented state for a remote control interval; receiving remote user input comprising coordinates mapped to display-space coordinates of a user interface of the agricultural display;
identifying a target user interface element based on the display-space coordinates and a hierarchical representation of the user interface; and
applying one or more remote-interaction safety rules, wherein when permitted under the one or more remote-interaction safety rules, a simulated input event is delivered to the target user interface element, and when not permitted, the simulated input event is suppressed and a denial indicator is rendered on at least one of the agricultural display and the remote terminal.

17. The non-transitory computer-readable medium of claim 16, wherein the one or more remote-interaction safety rules include one or more of a prohibition against remotely triggering mechanical operations and a prohibition against remote activation while an associated mechanism is in a mid-maintenance state.

18. The non-transitory computer-readable medium of claim 16, wherein the operations further comprise traversing ancestor elements in the hierarchical representation to detect a remote-click-prohibited flag or an object name in a prohibited list, and suppressing the simulated input event upon such detection.

19. The non-transitory computer-readable medium of claim 16, wherein the operations further comprise selecting a frontmost or lowest-in-hierarchy element intersecting the display-space coordinates when multiple user interface elements overlap the display-space coordinates.

20. The non-transitory computer-readable medium of claim 16, wherein the operations further comprise enforcing a session timer that terminates the control-consented state upon expiration, and requiring renewed in-cab consent to continue remote control.
